(19) United States
(12) Patent Application Publication
(10) Pub. No.: US 2007/0007186 A1
(43) Pub. Date: Jan. 11, 2007

(54) Oil reconditioning device and associated methods

(76) Inventor: Matthew Luntz, Highland, UT (US)

Correspondence Address: THORPE NORTH & WESTERN, LLP., 8180 SOUTH 700 EAST, SUITE 200, SANDY, UT, 84070, US

(21) Appl. No.: 11/177,513

(22) Filed: Jul. 8, 2005

(51) Int. Cl. B01D 35/18

(52) U.S. Cl. 210/97; 210/767; 210/774; 210/180; 210/123; 210/194

(57) ABSTRACT

A device and method for reconditioning oil or vaporizing volatile fluids from oil of internal combustion engines in order to extend the oil service life is provided. Such a device can include a housing having an internal and external surface which defines an enclosed open chamber which can receive heated engine oil. A coating having a thermal conductivity lower than that of the housing can cover at least a portion of the internal surface. An engine oil inlet, a vapor outlet, and a reconditioned oil outlet may be coupled to the housing. The coating can provide heat retention and other benefits to the device, thereby enhancing the volatile fluids vaporization process and increasing the service life of the device. In addition, the separation of volatile fluids can be affected using either spraying or thin film. The reconditioned oil has a significant reduction in water and fuel content thus allowing for increased service intervals and increased useful oil life.

### FIELD OF THE INVENTION

The present invention relates generally to oil reconditioning devices used in internal combustion engines and in particular to devices and methods for the continuous removal of volatile fluids and contaminants, such as water and fuel, found in engine lubricating oil. Accordingly, the present application involves the fields of chemistry, materials science, and thermodynamics.

### BACKGROUND OF THE INVENTION

Internal fuel combustion engines are used in a variety of circumstances such as automobiles, marine crafts, aircrafts, locomotives, diesel trucks, stationary diesel engines, to name a few. All internal combustion engines have moving parts which are susceptible to wear and damage during operation due to the presence of foreign material and/or breakdown of engine oil. Engine oils are used to lubricate interfaces or surfaces between the moving parts; however, volatile fluids and contaminants found in engine oils can significantly reduce the useful service life of the oil. Many have realized that engine oils having an extended service life can provide wide spread benefits, therefore attempts have been made to accomplish this purpose.

Generally, a number of methods and approaches have been implemented by those in the industry to extend the engine oil service life. One specific approach has been to formulate oils to include various additives. For example, additives can be designed to reduce or prevent oxidation, prevent oil breakdown, and/or reduce agglomeration of particulates. In addition, specific additives such as viscosity modifiers have also been used to extend the temperature range over which the oils operate thereby improving the service life of the oil. However, such additives typically have a finite period of usefulness until the additive is exhausted or otherwise rendered ineffective.

Another common approach for extending oil service life is to filter the oil in an attempt to remove particulate matter. Typically, full flow particulate filters are utilized to filter particulates to extend service life. These particulate filters have become a standard in internal combustion engines, however, merely removing particulates from engine oil only accounts for a portion of the contaminants. The presence of water and other volatile fluids in lubricating engine oils can also reduce the service life of the oil and can be detrimental to internal engine performance. Moisture or volatile fluids can result in the production of unwanted corrosion and oxidation producing acids and additional particulates.

Previous attempts to develop processes which reduce water content or other volatile fluids from engine oil have been met with varying degrees of success. Some of these processes have utilized surfaces with varying shapes to form a thin film of oil which may increase the vaporization rate of volatile fluids. Additionally, heat may be applied to these surfaces to increase the temperature of the oil thereby further facilitating the vaporization of the volatile fluids.

Although these previous attempts have improved oil quality and extended service life to some degree, there are limits as to their commercial practicability. Therefore, while arguably effective, each of these attempts suffers from problems such as unreliable performance, increased chamber retention times, limited practicality, inefficiency, increased costs, and other deficiencies which prevent their widespread use.

As such, systems and methods offering removal of volatile fluids thereby providing improved oil quality and extended service intervals, and which are suitable for use in practical applications continue to be sought through ongoing research and development efforts.

### SUMMARY OF THE INVENTION

Accordingly, the present invention provides devices and methods for removing contaminants such as water and volatile fluids from engine lubricating oil to extend the oil service life. The device provided by the present invention may include a housing having an internal and external surface which defines an enclosed open chamber. Furthermore, a coating can be applied to at least a portion of the interior surface. The coating can have a thermal conductivity lower than that of the thermal conductivity of the housing, thereby providing a device with an overall reduction in thermal conductivity. An engine oil inlet may be coupled to the housing and be in fluid communication with the open chamber to allow the heated engine oil to flow into the open chamber such that volatile fluids are vaporized from the heated engine oil to form a reconditioned oil. In addition, a vapor outlet and a reconditioned oil outlet may be in fluid communication with the open chamber to allow removal of volatile fluids and reconditioned oil, respectively. In one embodiment, the reconditioned oil outlet may be oriented below each of the engine oil inlet and the vapor outlet to facilitate the removal of the reconditioned oil.

In one alternative aspect, a method of using the oil reconditioning device, as recited herein, is provided. Such a method may include introducing a pressurized heated engine oil into the enclosed open chamber through the engine oil inlet. The open chamber may be at a lower pressure than the pressurized heated engine oil to facilitate vaporization of volatile fluids found in the heated engine oil. Typically, the open chamber has a pressure that is about ambient, and can generally be from about ambient to about 100 psig. As a result, a significant portion, e.g., typically up to about 90%, of the volatile fluids are vaporized. Once vaporized from the heated oil, the volatile fluids may be vented from the open chamber through a vapor outlet. The resultant oil is a reconditioned oil which has reduced water content and volatile fluids thereby allowing for extended service life. Removing the reconditioned oil can then be accomplished through an oil outlet which may be oriented below each of the engine oil inlet and vapor outlet. The reconditioned oil can then be recirculated to the engine.

In yet another aspect, a method of producing an oil reconditioning device as recited herein is provided. Such a method may include forming a housing having a predetermined configuration which defines an enclosed open chamber which is capable of retaining a fluid. A coating can be applied to at least a portion of the internal surface of the housing. In addition, an engine oil inlet, a reconditioned oil outlet, and a vapor outlet may be coupled to the housing and may be in fluid communication with the open chamber.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a schematic drawing of an oil reconditioning device in accordance with one embodiment of the present invention including a nozzle inlet.

FIG. 2 is a schematic drawing of an oil reconditioning device in accordance with an alternative embodiment of the present invention.

FIGS. 3a and 3b are schematic drawings of an oil reconditioning device and a powered return mechanism in accordance with some embodiments of the present invention.

The drawings will be described further in connection with the following detailed description. Further, these drawings are not necessarily to scale and are by way of illustration only such that dimensions and geometries can vary from those illustrated.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an,” and “the” include plural referents unless the context clearly dictates otherwise. Thus, for example, reference to “an outlet” includes one or more of such features, reference to “an interior surface” includes reference to one or more of such surfaces, and reference to “a coupling step” includes reference to one or more of such steps.

Definitions

In describing and claiming the present invention, the following terminology will be used in accordance with the definitions set forth below.

As used herein, “reconditioned oil” means an oil that has been restored, improved or purified by at least removing volatile fluids therefrom so as to improve oil performance and to extend the useful service life of the oil. The engine oil can be any oil that can be used in an internal combustion engine for lubricating purposes.

As used herein, “volatile fluid” refers to any fluid that can be readily vaporized. Particularly, as used herein, volatile fluid refers to any fluid that has a lower boiling point than engine oil and can functionally be evaporated from the engine oils. Non-limiting examples of common volatile fluids include water and combustible fuels such as gasoline and diesel.

As used herein, “atomizing” refers to reducing engine oil flow to fine particles, droplets, or a fine spray. Thus, atomizing of the engine oil can significantly increase exposed surface area such that migration of volatile fluids within the engine oil toward oil droplet surfaces occurs and volatilization thereof are enhanced.

As used herein, “bypass” refers to a process that is configured to treat only a portion of the circulating engine oil. For example, the present invention may be capable of treating from about 2 vol % to about 40 vol %, and preferably about 10 vol % to about 25 vol % of the total circulating engine oil, although the specific capacity can be designed to accommodate a wide variety of applications.

As used herein, “full flow” refers to processing or filtering substantially all of the total circulating engine oil.

As used herein, “enclosed” refers an area that is substantially or completely surrounded by a housing, which defines an internal space or area, which can be substantially open. Thus, an enclosed area is isolated from ambient conditions by various materials such as housing walls, valves, and the like.

As used herein, “open chamber” refers to a space that is substantially or completely enclosed by a rigid material. In accordance with the present invention, the open chamber may be defined by walls and may have inlets and outlets to form a partially open chamber.

As used herein, “thermally coupled” refers to a relationship of identified elements such that thermal energy can be transferred from one element to another element. Thermally coupled elements typically involved direct physical contact, although any configuration which allows conduction, convection, and/or radiation transfer of useful quantities of heat can be used.

As used herein, “supplemental heating source” refers to any heating source which is used to heat the oil other than the intrinsic heating resulting from passage through the cavities of an operating engine. Examples of supplemental heating sources can include electrical resistive heating elements and the like.

As used herein, “metallic” refers to a metal, or an alloy of two or more metals. A wide variety of metallic materials are known to those skilled in the art, such as aluminum, copper, chromium, iron, steel, stainless steel, titanium, tungsten, etc., including alloys and compounds thereof.

As used herein, “substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context. Similarly, “substantially free of” or the like refers to the lack of an identified element or agent in a composition. Particularly, elements that are identified as being “substantially free of” are either completely absent from the composition, or are included only in amounts which are small enough so as to have no measurable effect on the composition.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

It should be noted that when referring to items in the figures, certain numerals from one figure to the next denote similar structures. Thus, it is not necessary to re-identify each and every numeral in each figure where a new feature is to be described.

The Invention

The present invention is drawn towards devices and methods that offer an effective and economical option for removing volatile liquid contaminants from lubricating engine oils. Specifically, the present invention can be used to recondition engine oil and remove volatile contaminant fluids that may cause damage to internal combustion engines.

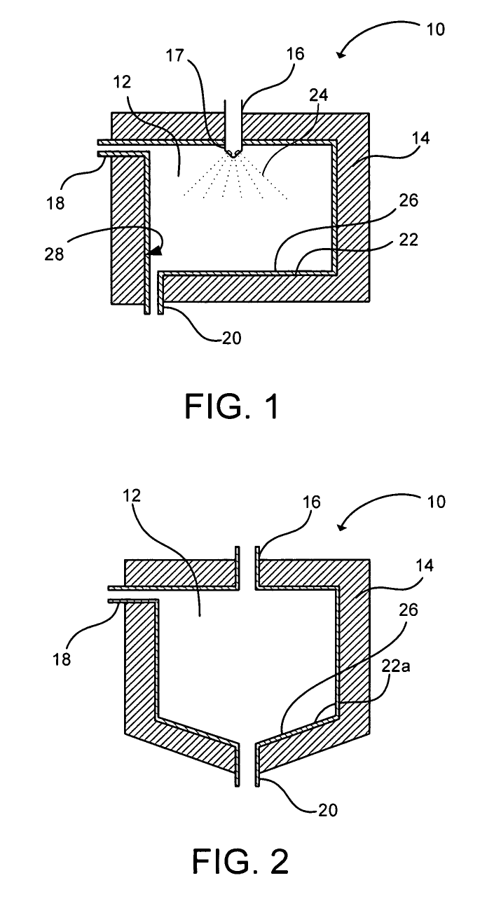

Referring now to FIG. 1, an oil reconditioning device is shown generally at 10 in accordance with one embodiment of the present invention. A housing 14 having an internal surface 28 and an external surface can be shaped in a desired configuration to define an enclosed open chamber 12. The housing can contain an engine oil inlet 16, a vapor outlet 18, a reconditioned oil outlet 20 oriented below each of the engine oil inlet and vapor outlet, and a coating 26 covering at least a portion of the internal surface.

The housing 14 may be formed into any shape that defines an enclosed open chamber 12 and is capable of retaining fluids. Generally, the housing can be formed in a variety of shapes, such as a cylinder, cone, or rectangular chamber. In one aspect, the housing can be formed in a rectangular shape having a substantially flat bottom surface 22 as shown in FIG. 1. In an alternative embodiment, a bottom portion of the housing can be formed in a conical shape as shown in FIG. 2, having a bottom surface 22a sloping downward to an oil outlet 20. This sloped configuration can facilitate the removal of reconditioned oil by allowing gravity to direct the reconditioned oil down to and out through the oil outlet.

A variety of rigid materials may be used for the fabrication of housing 14. Preferably, the housing can be fabricated from materials that are capable of retaining fluids and withstanding temperatures up to about 150° C., and preferably up to about 225° C. without deforming. Most of the materials described below operate well above these temperatures; however, the reconditioning device is typically not operated over about 150° C. In addition, the open chamber 12 can be at a lower pressure than the pressurized heated engine oil. Therefore, the housing should also be fabricated from materials that can withstand pressures up to about 100 psig. Specific examples of materials that can be used include without limitation, stainless steel, cast iron, aluminum, plastic, ceramic, and alloys or composites thereof. In some embodiments the housing can comprise or consist of a metallic material. In one embodiment, the metallic material may be aluminum, or an aluminum alloy. In another embodiment, the metallic material may be stainless steel, or a stainless steel alloy. Important considerations when choosing materials include providing materials that have a sufficient rigidity and toughness. Aluminum for example, is easily formable, rigid, light weight, and also cost effective. In another embodiment, the housing can be formed of a ceramic material. Many ceramic materials can exhibit desirable thermal properties such as relatively low thermal emissivity and thermal conductivity. Some housing materials are more suitable for reconditioning oils than others. Generally, suitable materials are chosen based upon the thermal conductivity, structural integrity, expense, and anti-corrosive properties.

The housing material can be formed into the housing 14 using any number of techniques such as metal casting, die casting, or machining processes, to name a few. In one embodiment, an aluminum housing may be formed by a die casting process. One forming process may be desirable over another depending on the materials being formed into the housing. The forming process can account for design configurations that allow for fluidly coupling a spray nozzle 17 to the engine oil inlet 16, and spraying an oil trajectory into the open chamber such that the oil spray trajectory is substantially unimpeded. In other words, the housing can be formed such that the open chamber 12 does not have any protrusions that might obstruct the sprayed oil trajectory. In this way, the oil may achieve the desired particle size and surface area configuration.

Additionally, the internal surface 28 of housing 14 or at least a portion of the internal surface may be coated with a coating material 26 which is designed to improve heat transfer to the oil. In one embodiment, the coating may be a high performance coating covering substantially the entire internal surface. Non-limiting examples of coatings that may be used in accordance with the present invention can include, ceramics, polymers such as polysiloxanes, poly (diarylsiloxy) arylazines, aliphatic polyester polyols, epoxies, quasicrystals and composites thereof. In one embodiment the coating can be a quasicrystalline AlCuFe alloy film applied to the internal surface of the housing. Other organic or inorganic materials can be used as coatings as long as they are sufficiently durable and degradation resistant under typical operating temperatures and conditions. Organic polymer coatings are currently preferred for their durability, thermal properties, cost, and ease of application.

In accordance with the present invention, a coating having a lower thermal conductivity than that of the housing can be applied to the housing to provide an overall reduction in thermal conductivity to the reconditioning device. For example, some embodiments of the coating can reduce heat loss of the device to the surroundings by about 58 W to about 60 W as compared to a device lacking these coatings. In addition, the coating can provide the device with anti-corrosion properties, thereby extending the service life and structural integrity of the housing.

In accordance with the present invention, the oil generally enters the open chamber at a temperature of about 90° C. to about 150° C. A coating having low emissivity properties and capable of retaining heat, can be applied to a housing to retain heat and reduce the heat transfer to the surroundings. The retained heat can increase the temperature of the coated surface, thereby increasing or retaining average molecular motion to retain heat with respect to the entering engine oil. Any functional thickness of the coating can be used. However, in some embodiments the coating can be applied to internal surface of the housing at a thickness of about 10 micrometers to about 3 mm. In an alternative embodiment the coating can be applied to an internal surface at a thickness of about 40 micrometers to about 1 mm.

The coating may be applied by various process such as, but not limited to, spraying, dipping, rolling, wiping, brushing, vapor depositing, and combinations thereof. The applying process is dependant upon the type of coating being applied. For example a thin film layer of quasicrystalline may be formed by depositing in sequence on a substrate through radio frequency sputtering a stoichiometric amount of each respective alloy material and then annealing those layers to form the film through solid state diffusion.

An optional heating source, such as an electrical heating element may be operatively coupled to the housing 14 in some embodiments. Typically, the heating source is thermally coupled upstream of the engine oil inlet 16 in order to supply heat to the already heated engine oil. Alternatively, the heating source may be physically or thermally coupled at any location either on the top, bottom, or sides of the housing, thereby providing a heating source which is capable of maintaining or increasing the temperature of the engine oil as it enters the open chamber 12. Notably, the increase in temperature can decrease the vaporization time needed for removing volatile fluids entrained in the engine oil. There are a number of supplemental heating sources that may be employed by the present invention. Generally, any heating source that is capable of supplying heat to the engine oil can be utilized. Currently, an electrical heating element can be a preferred heating source as such can be operatively connected to the vehicle electrical system. In this manner, additional heat can be supplied to the engine oil sufficient to increase vaporization of undesirable volatile fluids.

In one embodiment, the housing 14 can have an engine oil inlet 16 in fluid communication with the chamber 12 thereby providing a passage for introducing engine oil into the open chamber. Most often the engine oil entering the open chamber can have an inlet temperature from about 50° C. to about 150° C., and a pressure from about 25 psig to about 100 psig. However, temperatures and pressures outside these ranges can also be useful, e.g., startup temperatures may be substantially below the above temperature range. Most often, typical engine operating temperatures range from about 90° C. to about 110° C. Typically, the engine oil enters an open chamber through the oil inlet at a flow rate from about 5 gph to about 25 gph. However, it should be kept in mind that the reconditioning devices of the present invention can be sized for larger or smaller applications, e.g., moped engines, large marine vessels, industrial oversized dump trucks, etc. The flow rate of the engine oil may be adjusted to increase or decrease the oil retention time in the chamber. Increasing the retention time may allow the oil additional time to more completely vaporize and separate the volatile fluids from the oil. One method for adjusting the flow rate and separation efficiency can be to couple a spray nozzle 17 to the oil inlet.

There are a number of nozzles that can be coupled to the engine oil inlet 16 which may alter the flow rate and increase the surface area of the entering engine oil. Specific examples of nozzles that can be used included without limitation, a spray nozzle, an atomizing nozzle, a free flowing nozzle, a hollow cone nozzle, a flat fan nozzle, a spiral cone nozzle, to name a few. In one embodiment, the spray nozzle 17 coupled to the engine oil inlet can be an atomizing nozzle. Typically, any nozzle that increases the surface area of the entering engine oil can be employed by the present invention. Generally, spray nozzles increase the surface of the engine oil by forming oil droplets. Droplet size, spray pattern and vaporization rate can be altered depending on the nozzle used.

Since volatile fluids are typically at least partially well mixed into the oil, i.e. as a partial solution, emulsion or dispersion, increasing the surface area of the oil can increase the evaporation rate of the volatile fluids. Specifically, the increased surface area facilitates the migration of the volatile fluids to the surface of the oil where they can easily evaporate into the open chamber 12. Therefore, the greater the oil surface area or the more droplets formed, the greater the rate of vaporization of the volatile fluids. For this reason, introducing engine oil into the open chamber through a spray nozzle can be advantageous for increasing the engine oil surface area.

In one embodiment, at least one spray nozzle 17 can be coupled to the engine oil inlet 16. The spray nozzle can be in fluid communication with the open chamber 12 thereby providing a passage for spraying engine oil into the open chamber. Additionally, the spray nozzle may be coupled at any functional location of the housing. For example, the spray nozzle can be located either on the top, bottom, or sides of the housing, depending on the particular configuration. In one embodiment the nozzle can be coupled to the side of the housing at any point above reconditioned oil which collects at the bottom of the open chamber. When coupled to the side of the housing the spray nozzle may be adjusted such that the nozzle may spray engine oil radially and upward along a diagonal trajectory. This type of configuration may increase the vaporization efficiency of volatiles entrained in the oil by extending the oil retention time in the open chamber, thereby allowing for more of the volatiles to be removed from the oil. Adjusting the flow rate of the engine oil as it is sprayed into the open chamber can also increase or decrease the oil retention time in the chamber. Increasing the retention time by reducing flow rates can allow the oil additional time to more completely vaporize and separate the volatile fluids from the oil.

Another way to achieve an optimal spray configuration can be to utilize and couple a plurality of spray nozzles to the engine oil inlet (not shown). A plurality of spray nozzles may be needed to obtain the desired droplet size and flow rate of oil entering the chamber. For example, in one embodiment, two air atomizing spray nozzles may be attached and positioned at the top of the housing and configured to mist the engine oil into the open chamber, thereby increasing the total flow rate of oil entering the open chamber, while obtaining an optimized droplet size. Alternatively, spray nozzles can be positioned along a plurality of housing walls. For example, one or more spray nozzles can be located along each of the side walls and/or top of the housing.

As previously mentioned, various spray patterns may be adapted by spray nozzles to further increase engine oil surface area. Since a variety of open chamber configurations and shapes may be used in accordance with the present invention, spray width, concentration and pattern should be considered when determining the optimal spray pattern for each configuration. Accordingly, the present invention may employ a number of spray patterns which may include without limitation, hollow cone spray, full cone spray, flat spray, fine spray, and air atomizing spray patterns. In one embodiment, the spray pattern may be an air atomizing spray pattern. In another embodiment, the oil may be sprayed into the open chamber 12 in a hollow cone spray pattern. The hollow cone spray pattern provides concentrated oil particle spray around a perimeter, while leaving the center of the spray substantially empty. As a result, the concentration gradient of volatiles between exposed droplets and adjacent areas can be maximized to maintain an increased driving force for vaporization. Generally, any spray pattern may be adjusted such that the surface area of heated engine oil entering the open chamber may be maximized. Depending on the position and configuration of the outlet as described below, the spray pattern can be adjusted for additional retention time within the chamber prior to removal of the reconditioned oil.

Alternatively, the engine oil inlet 16 may be configured to allow direct unimpeded fluid flow into the open chamber 12. Specifically, the engine oil inlet may be substantially free from obstructions or a reduction in aperture size, thereby allowing the heated oil to freely flow uninterrupted into the open chamber. This configuration may be conducive for thin-film evaporation of the heated engine oil. In a thin-film evaporation, the heated engine oil flows over an interior surface as a thin film of oil. As the oil contacts the interior surface, a thin film of oil can be created, thereby increasing the surface area of oil and the evaporation rate of the volatile fluids. Typically, the thin film can be from several microns to about one millimeter in thickness, depending on the flow rate.

The interior surface can be configured to contain various contours that improve the forming of a thin film. The interior surface can include contours which allow for increased retention time as a thin film. For example, the bottom surface of the chamber may be configured to contain a concave or convex surface. As the thin film forms, volatile fluids migrate to the exposed surfaces of the engine oil and are readily vaporized from the heated engine oil into the surrounding environment of the chamber. The resultant oil is a reconditioned engine oil having a reduced or depleted content of volatile fluids. The thin film surface can alternatively have almost any contour which allows for flow of a thin film. Non-limiting examples of contours which can be used include convex, concave, stepped concave, multiple convex surfaces, and the like.

As the volatile fluids become vaporized in the open chamber 12, a vapor outlet 18 can be placed in the housing 14 and configured to allow removal of volatile fluids from the open chamber. Typically, the vapor outlet will be positioned above any outlets 20 that may be coupled to the open chamber. The vapor outlet may be positioned and shaped into any configuration that allows for the volatilized gases to vent from the open chamber. The vapor outlet can be provided in the form of an open outlet, a pressure relief valve, or any other functional member which allows for removal of volatilized fluids without compromising separation performance. In one embodiment, a plurality of vapor outlets may be coupled to the housing and which are in fluid communication with the open chamber. As previously noted, once the volatile fluids are vaporized from the engine oil, the resultant oil can be collected and removed from the open chamber as a reconditioned oil.

Removal of the reconditioned oil may be accomplished by a reconditioned oil outlet 20 coupled to the housing 14 which is in fluid communication with the open chamber 12. The oil outlet provides a passage for the desired oil to exit and return to the oil sump, engine block, or other unit of the engine system. The reconditioned oil outlet is typically oriented below each of the engine oil inlet and vapor outlet, although this is not always required. Notably, the reconditioned oil outlet may be coupled to a side wall of the housing. Alternatively, the reconditioned oil outlet may be coupled to a bottom surface of the housing, thereby allowing gravity to remove the reconditioned engine oil as shown in FIG. 2. By orienting the oil outlet below each of the oil inlet 16 and vapor outlet 18, gravity can be used as the primary force to remove the reconditioned oil from the unit 10. Further, problems associated with clogging or blockage of the oil inlet or vapor outlet can be avoided by placing the outlet below each of the spray nozzle and vapor outlet.

Additional features may be included with the present invention to improve the removal of the reconditioned oil from the device. For example, a powered return mechanism can be coupled to the device. Accordingly, the powered return device may be operatively connected to the oil reconditioning device such that reconditioned oil is forced out through the reconditioned oil outlet. Non-limiting examples of powered return mechanisms which can be used include a negative pressure device, a pneumatic float valve, a co-impeller, and an electrical pump. Various means for forcing the reconditioned oil from the reconditioning device can be considered. The above listed powered return mechanisms include the currently preferred means for forcing oil from the reconditioning device.

Further, it has been discovered that using a standard ½″ drain line under gravity flow in connection with the present invention can in some embodiments allow air and gas bubbles to be trapped in the line causing blockage. Accordingly, a ¾″ or larger line can be used to alleviate this difficulty. Unfortunately, not all engines are equipped with ports of this size. A powered return mechanism such as those described herein can be used to allow use of the standard size line without sacrificing performance.

Incorporating a negative pressure device with the present invention can increase the flow of the reconditioned oil and avoid any clogging or blockage associated with the oil returning to the engine. Typically, the negative pressure device can include a reconditioned oil line fluidly coupled to the reconditioned oil outlet and an oil return line. In this embodiment the reconditioning device may be configured as an oil bypass device, treating only a portion of the total circulating oil and redirect the reconditioned oil to an oil return line, as described below.

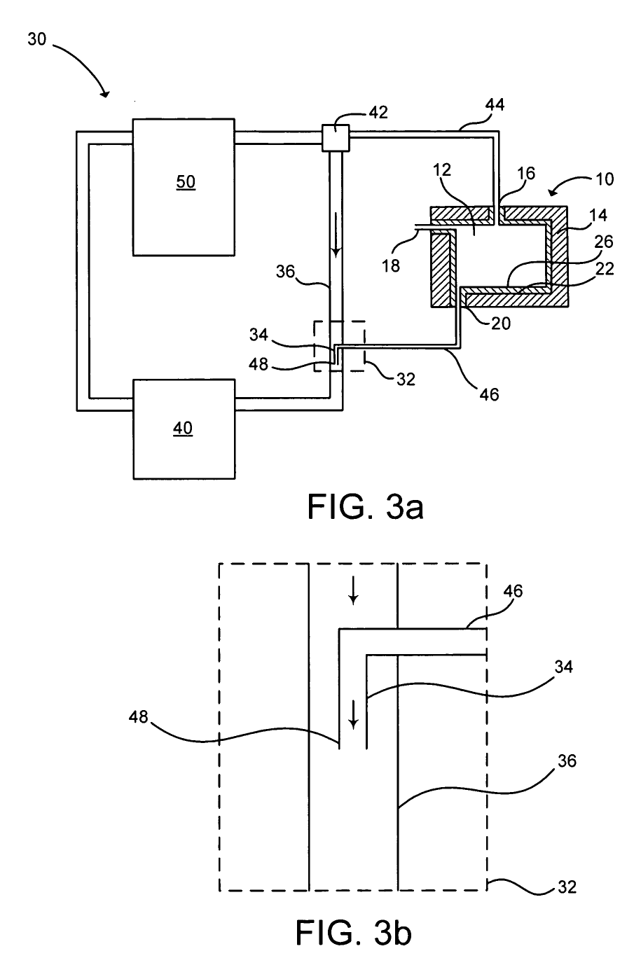

Referring now to FIGS. 3a and 3b, an engine oil purifying system 30 can include a full flow particulate filter 50 and an oil reconditioning device 10 fluidly coupled. Typically, lubricating oil circulates from an engine 40 to a full flow particulate filter 50. The particulate filter can remove relatively large particulates from the circulating engine oil, as described below. Upon exiting the full flow particulate filter, the engine oil can pass through an oil separator 42, e.g. an open T junction or the like. Generally, the separator is capable of directing a portion of the circulating oil to an oil return line 36 and an oil inlet line 44 fluidly coupled to the engine oil inlet 16 of the oil reconditioning device.

As shown in FIG. 3a, the oil flow rate through each of oil return line 36 and oil inlet line 44 can be controlled and or designed to obtain a desired flow rate through the reconditioning device. For example, the reconditioning device may continuously treat from about 2 vol % to about 40 vol % of the total engine oil. The relative oil flow rates can be adjusted by appropriate choice of the diameter of an inlet line connected to the reconditioning device. In one embodiment, the oil inlet line can be fluidly coupled to the engine oil inlet 16 and can have a diameter that corresponds to desired fluid flow. In another embodiment, the engine oil inlet can originate from an engine oil return line and can have a diameter less than the engine oil return line. A smaller diameter can result in a lower oil volume percent being treated and a lower fluid flow rate as compared to the fluid flow rate in the engine oil return line.

The volatile fluids can be removed through a flash vaporization process once the oil enters the open chamber 12, resulting in a reconditioned oil as described herein. The reconditioned oil can then be removed through the use of a pressure differential driven mechanism from the open chamber through the reconditioned oil outlet 20 positioned below the engine oil inlet and the vapor outlet 18. A negative pressure device 32 can include a reconditioned oil return line 46 being fluidly coupled to the reconditioned oil outlet. The reconditioned oil return line can have an end portion 34 distal to the reconditioned oil outlet and which can be concentrically oriented within the oil return line. The end portion can be oriented having an opening 48 thereof directed downstream with the fluid flow from the oil return line. As oil flows past the opening 48, the flowing fluid creates a negative pressure within the reconditioned oil return line 46, thereby increasing the flow and removal of the reconditioned oil from the open chamber. This powered return embodiment is currently preferred over others because of an absence of moving parts or complex designs and do not require connection to pneumatic, electric, or other additional systems.

FIG. 3b, illustrates an enlarged view of the negative pressure device 32 having a reconditioned oil return line 46 fluidly coupled to the reconditioned oil outlet and an oil return line 36. Particularly, FIG. 3b illustrates the reconditioned oil return line having an end portion 34 distal to the reconditioned oil outlet and being concentrically oriented within the oil return line and oriented having an opening 48 thereof directed downstream.

As previously mentioned, other powered return mechanisms may be utilized in conjunction with the present invention. For example, a co-impeller (not shown) may be coupled to the oil return line 36 and a reconditioned oil return line 46. The co-impeller can be mechanically configured to be a fluid driven assembly. One impeller may be disposed within the oil return line and mechanically coupled to the other impeller disposed in the reconditioned oil return line, e.g. along a common axle. The impeller in the oil return line is driven by the oil as it flows through the line. Because the both impellers are mechanically coupled, the movement of the impeller in the oil return line drives the impeller in the reconditioned oil return line, thereby causing the reconditioned oil flow rate to increase.

Another embodiment of the powered return mechanism can include a pneumatic float valve coupled to the oil reconditioning device. A float valve is positioned in the chamber to contact the reconditioned oil at a predetermined level. Upon contact with the rising reconditioned oil, the float opens a pressurized air valve in the open chamber thereby releasing pressurized air into the chamber. The pressurized air increases the internal pressure of the open chamber and flushes the reconditioned oil out of the chamber and through the reconditioned oil outlet. This embodiment is particularly suited for use in vehicles that utilize a pneumatic system such as, diesel trucks.

In yet another embodiment, the powered return mechanism can be an electric pump fluidly coupled to the reconditioned outlet such that the reconditioned oil may be pumped out of the reconditioned device and back to the oil pan or sump at a predetermined flow rate. An electrical pump can be readily installed in most vehicles directly into the existing vehicle electrical system.

Removal of volatile fluids from the engine oil can be considered at least as important as removing solid particulates from the engine oil such as metal shavings, particulate materials, etc. Full flow particulate filters may be used in conjunction with the present invention to filter out these particulates. The full flow filters are typically designed to allow for sufficient oil flow such that the engine is not starved of oil. Generally, the full flow filters are considered primary filters that remove particulates in the range of about 1 micron to about 50 microns from engine oil. The size of the particles filtered is determined largely based upon the filter mesh size. However, as discussed above, these types of full flow filters lack the ability to remove other contaminants such as water, and other volatile fluids. Therefore, it can be advantageous to utilize a full flow particulate filter in conjunction with, or parallel with, a reconditioning device as disclosed herein.

In one embodiment, an oil reconditioning device can be mounted in fluid communication with a full flow particle filter as a single integrated unit. In another embodiment, an oil reconditioning device may be mounted in fluid communication as a separate unit in series with a full flow particle filter. The full flow filter can thus remove particulates from the entering oil stream prior to introduction of the oil into the reconditioning unit. Therefore, the full flow filter can be operatively connected to or positioned upstream from the engine oil inlet.

The reconditioning device 10 as recited herein can be used in a secondary or a bypass configuration such that only a portion of the total engine oil is circulated through the reconditioning device. Alternatively, the reconditioning device can be configured as a full flow reconditioning device. The reconditioning devices of the present invention are generally very effective at removing volatile fluids from the engine oil. At standard operating conditions, the reconditioning devices of the present invention can remove from about 85 vol % to about 95 vol % (in a single pass) of volatile fluids from the engine oil, and typically about 90 vol %. Since the devices of the present invention are highly effective at removal of volatile fluids, the device is generally used as a bypass instead of a full flow. A bypass configuration generally works in conjunction and preferably in series with full flow filters. A typical bypass configuration can continuously treat a portion of the total circulating engine oil. In accordance with one aspect of the present invention, the reconditioning device may continuously treat from about 2 vol % to about 40 vol %, and often from about 2 vol % to about 15 vol % of the total engine oil, although other flow rates can be designed depending on the particular engine and intended operating conditions. Reconditioning devices configured in a bypass configuration can purify the engine oil from fluid contaminants such as water and fuel that a conventional full flow particulate filter cannot, to produce a substantially continuously reconditioned engine oil having an extended service life.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. An oil reconditioning device, comprising:
a) a housing defining an enclosed open chamber, said housing having an internal surface, an external surface, and a first thermal conductivity;
b) a coating covering at least a portion of the interior surface, said coating having a second thermal conductivity lower than that of the first thermal conductivity;
c) an engine oil inlet coupled to the housing and in fluid communication with the open chamber and configured to direct a heated engine oil into said open chamber such that volatile fluids are vaporized from said heated engine oil to form a reconditioned oil;
d) a vapor outlet in fluid communication with the open chamber for removal of the volatile fluids; and
e) a reconditioned oil outlet in fluid communication with the open chamber for removal of the reconditioned oil.

2. The device of claim 1, wherein the coating covers substantially the entire internal surface.

3. The device of claim 1, wherein the coating comprises a member selected from the group consisting of ceramics, polysiloxanes, poly (diarylsiloxy) arylazines, aliphatic polyester polyols, epoxies, quasicrystals, and composites thereof.

4. The device of claim 1, wherein the coating comprises an organic polymer.

5. The device of claim 1, wherein the coating has a thickness from about 10 micrometers to about 3 mm.

6. The device of claim 1, further comprising a heating element thermally coupled to the housing to supply additional heat to the heated engine oil.

7. The device of claim 1, further comprising a spray nozzle operatively connected to the engine oil inlet.

8. The device of claim 7, wherein the spray nozzle is an atomizing nozzle.

9. The device of claim 7, wherein the spray nozzle is configured to spray the heated engine oil along a substantially unimpeded trajectory into the open chamber.

10. The device of claim 1, wherein said device is configured for use as an engine oil bypass device capable of treating a portion of total engine oil.

11. The device of claim 1, further comprising a powered return mechanism operatively connected to the device to force the reconditioned oil out the reconditioned oil outlet.

12. The device of claim 11, wherein the powered return mechanism is a negative pressure device, a pneumatic float valve, a co-impeller, or an electrical pump.

13. The device of claim 12, wherein the powered return mechanism is a negative pressure device fluidly coupled to the reconditioned oil outlet, said device comprising:
a) an oil return line; and
b) a reconditioned oil line fluidly coupled to the reconditioned oil outlet and the oil return line, said reconditioned oil line having an end portion distal to the reconditioned oil outlet, said end portion being concentrically oriented within the oil return line and oriented having an opening thereof directed downstream.

14. A method for reconditioning oil using the device of claim 1, comprising the steps of:
a) introducing a pressurized heated engine oil into the enclosed open chamber through the engine oil inlet, such that volatile fluids are vaporized from said heated engine oil to form a reconditioned oil;
b) venting the vaporized volatile fluids from the open chamber through the vapor outlet; and
c) removing the reconditioned oil through the oil outlet.

15. The method of claim 14, further comprising the step of increasing the surface area of the heated engine oil in the open chamber.

19. The method of claim 18, wherein the step of increasing the surface area of the heated engine oil is accomplished by spraying.

20. The method of claim 18, wherein the step of increasing the surface area of the heated engine oil is accomplished by contacting the heated engine oil with the internal surface of the open chamber to form a thin film of the heated engine oil.

21. A method of making the device of claim 1, comprising:
forming the housing;
applying the coating to at least a portion of the internal surface; and
coupling the engine oil inlet, the vapor outlet and the reconditioned oil outlet to the housing.

22. The method of claim 21, wherein the step of applying is accomplished by a process selected from the group consisting of spraying, dipping, rolling, wiping, brushing, vapor depositing, and combinations thereof.

23. The method of claim 21, further comprising the step of thermally coupling a heating element to the housing.
